(19) United States
(12) Patent Application Publication
(10) Pub. No.: US 2011/0044356 A1
(43) Pub. Date: Feb. 24, 2011

(54) SYSTEM AND METHOD FOR MODE SELECTION BASED ON EFFECTIVE CINR

(75) Inventors: Zion Hadad, Rishon Lezion (IL); Doron Ezri, Tel Aviv (IL); Michael Erlihson, Tel Aviv (IL)

Correspondence Address: ROBERT G. LEV, 4766 MICHIGAN BLVD., YOUNGSTOWN, OH, 44505, US

(73) Assignee: Runcom Technologies Ltd., Rishon Lezion (IL)

(21) Appl. No.: 12/735,316

(22) PCT Filed: Dec. 23, 2008
(86) PCT No.: PCT/IL08/01660

§ 371 Date: Oct. 5, 2010

(30) Foreign Application Priority Data
Dec. 31, 2007 (IL) IL 188503
Dec. 31, 2007 (IL) IL 188504

(51) Int. Cl. H04B 15/00; H04J 1/00

(52) U.S. Cl. 370/480; 375/285

(57) ABSTRACT

Selecting an optimal ECINR mode in a digital communication system, by constructing an offline relevant modes database having a list of transmission-reception methods for possible MIMO configurations, and mobility characterization, gathering online channel state and capabilities information, retrieving parameters from the relevant modes database, based on the gathered data/information for creating a concurrent list, excluding some MIMO modes off the list, for which the available channel matrix is insufficient, the modes left at the end of this step being “currently relevant modes’, calculating post processing per tome physical CINR (PCINR) for each of the currently relevant modes found, calculating ECINR for each of the currently relevant modes using the PCINR, choosing the optimal MIMO mode and MCS combination, which is the parameters' combination with highest throughput, which provide the best ECINR under QoS requirements.

### FIELD OF THE INVENTION

This invention relates to mode selection techniques for communications systems and especially for selecting the optimal mode in various channel conditions.

### BACKGROUND OF THE INVENTION

Modern wireless communication standards require a high degree of flexibility on the physical layer (PHY) allowing the data link control (DLC) layer to choose transmission parameters with respect to the currently observed link quality. This possibility of so-called Link Adaptation. (LA) is a key element for meeting quality of service (QoS) requirements and optimizing system performance. The term Link Adaptation covers a variety of different techniques for choosing transmission parameters according to the channel condition and with respect to QoS parameters.

Because of the high degree of flexibility at the PHY layer, which is based on sophisticated protocols and also physical channel characteristics, it may be a complex task to select proper transmission parameters.

There may be important parameters that may affect transmission performance, thus a correct parameters' selection may be crucial for improving LA—which is a key element for meeting quality of service (QoS) requirements and optimizing system performance.

Achieving improved LA, may require utilizing a variety of different techniques for choosing transmission parameters, according to the channel condition and with respect to QoS parameters, thus there is a need to provide systematic methods and means for optimizing the LA.

The PHY mode selection (PMS) may be considered for improving LA. Nevertheless, PMS is governed by several parameters, including:
Type of MIMO mode
Modulation scheme,
Coding rate
Forward error correction (FEC) block size.

Various types of PMS schemes can be distinguished according to the underlying optimization criteria (QoS and throughput). Many of the existing LA techniques are based on a prediction of the packet error rate (PER) implied by a certain transmit parameter setting.

### PRIOR ART REFERENCES

[1] Mode selection for data transmission in wireless communication channels based on statistical parameters, U.S. Patent Application No. 20050031044, February 2005.
[2] Lampe, M.; Giebel, T.; Rohling, H. and Zirwas, W. Per-prediction for PHY mode selection in OFDM communication systems, Global Telecommunications Conference, 2003. GLOBECOM apos; 03. IEEE Vol. 1, 1-5 Dec. 2003 p. 25-29.
[3] Transmission mode selection for data transmission in a multi-channel communication system”, United States Patent 20040184398.
[4] Kyoung-Youn Doo; Jee-young Song; Dong-Ho Cho Enhanced transmission mode selection in IEEE 802.11a WLAN system Vehicular Technology Conference, 2004. VTC2004-Fall. 2004 IEEE 60^{th} Vol. 7, 26-29 Sep. 2004, p. 5059-5062.
[5] Hadad, Z., Ezri, D. and Erlihson, M. Generalization of the EESM method for Effective CINR calculation, patent application.
[6] Nortel, “Effective SIR Computation for OFDM system-level simulations,” 3GPP TSG-RAN WG1 #35, R1-031370, November. 2003.
[7] Ericsson, “Effective-SNR Mapping for Modeling Frame Error Rates in Multiple-state Channels,” 3GPP2-C30-20030429-010, November. 2003.
[8] D. Qiao and S. Choi, “Goodput Enhancements of IEEE 802.11a Wireless LAN via Link Adaptation,” in Proc. of IEEE ICC, vol. 7, pp. 1995-2000, June 2001
[9] D. Qiao and S. Choi, Kang G. Shin, “Goodput Analysis and Link Adaptation for IEEE 802.11a Wireless LANS,” IEEE Trans. on Mobile Computing, vol. 1, no. 4, pp. 278-292, October-December 2002.
[10] Gilbert et. al. U.S. Pat. No. 5,559,810

There is an extensive literature devoted to various aspects of LA (see references [1]-[4] and references therein). MAC Service Data Unit (MSDU)-based adaptive PHY mode selection scheme has been developed by Daji Qiao et. al. [8]. The root of this approach lies in goodput analysis. Goodput is defined as the number of successfully transmitted data bits during unit time for one station. The technique of [8] assumes the unchanged wireless channel during the transmission of all fragments and retransmission. The PHY mode is selected by a lookup table according to the SNR and MSDU size. An enhancement of this technique is discussed in [9], where a more realistic assumption that the channel remains constant over a single MPDU transmission period is made. Thus, mode selection can also be changed during the entire MSDU transmission period.

Gilbert et. al [10], suggested to use data reception history for mode selection. At least one data block is transmitted with a particular modulation scheme and the data reception history is maintained to indicate transmission errors by keeping the value of how many blocks had errors. The data reception history is updated and used for estimation of signal quality for each transmission scheme.

In [4] the physical carrier to noise and interference ratio (PCINR) estimator, performed by the receiver, was exploited for the LA procedure. This approach has been extended in [1], where a mode selection technique based on the first-order and the second order statistics of the PCINR measurements is suggested.

### SUMMARY OF INVENTION

A new mode selection technique is provided in the current application, which provides efficient and accurate means for selecting the optimal mode in various channel conditions. The new technique may be based on the effective carrier to noise and interference ratio (ECINR) concept. ECINR is defined as the AWGN-equivalent CINR, i.e. equivalent CINR in an AWGN channel that results in the same error rate.

In this application, PHY mode selection (PMS) is considered. PMS is defined as a selection of MIMO mode, modulation scheme, coding rate and forward error correction (FEC) block size. Various types of PMS schemes can be distinguished according to the underlying optimization criteria (QoS and throughput). Many of the existing LA techniques are based on a prediction of the packet error rate (PER) implied by a certain transmit parameter setting.

The methods in this application are efficient in a great variety of wireless systems, including Single Input Single Output (SISO), Multiple Input Single Output (MISO), Single Input Multiple Output (SIMO) and Multiple Input Multiple Output (MIMO). The proposed scheme can preferably be based on the ECINR prediction for several MIMO modes. The ECINR is calculated using the current (multidimensional) channel conditions among other parameters. Moreover, an optimal utilization of all available resources is guaranteed.

For example, when the transmitter and receiver are both endowed with multiple antennas, and are familiar with their mutual transmission and reception capabilities (e.g. through some capability exchange mechanism), there are multiple transmission methods available. These may include (among others), the Alamouti space-time coding (STC), spatial multiplexing (SM), closed loop (CL) MIMO and Beamforming (BF). Thus, it is necessary to choose the optimal transmission scheme in terms of throughput subject to the QoS requirements.

### BRIEF DESCRIPTION OF THE DRAWINGS

FIG. 1 details a method for selecting optimal mode in a digital communication system.

FIG. 2 details a hardware mechanism capable of selecting the optimal MIMO mode, FEC block size and modulation coding scheme (MCS) combination.

### DETAILED DESCRIPTION OF THE INVENTION

This invention will now be described by way of example, and with reference to the accompanying drawings.

A concept method for defining modes hierarchy will now be described. According to this concept method, some MIMO modes can be defined as always superior to others.

For instance, maximal ratio combining (MRC) is always superior to SISO, and STC combined with MRC is always superior to STC and MRC. This implies that as a superior mode is available, inferior modes should not be considered in the optimization process. According to this method, a superior method will be selected, when this is possible, so that improved performance will be provided. This is done under system limitations and available resources.

### Method for Selecting an Optimal Mode in a Digital Communication System

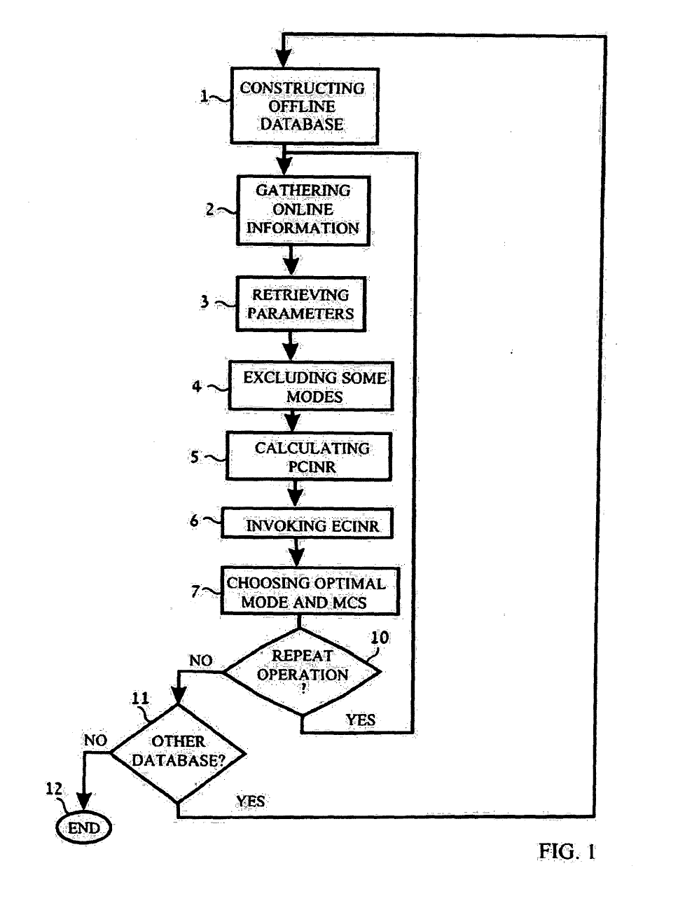

FIG. 1 details a method for selecting an optimal mode in a digital communication system.

The method described with reference to FIG. 1 may include the following steps:

### 1. Constructing an Offline Database Referred as: “Relevant Modes Database”.

This database includes a list of transmission-reception (TR) methods relevant for each of the MIMO configurations, and mobility characterization.

For instance, in case of a MIMO system with 2 transmit and 2 receive antennas in low mobility, the database will not include SISO, STC with single reception antenna, and MRC.

Moreover, in case of a MIMO system with 2 transmit and 2 receive antennas in high mobility, the database will also exclude CL MIMO and reciprocity base BF. Preferably, this database does not include information regarding modulation-coding scheme (MCS), but MIMO modes alone.

The database may be loaded, such as from a memory or from a wired or wireless network. Since the type of communication about to be made is known, it is possible to construct a database only with the relevant modes, which can be used in that session.

### 2. Gathering Online Channel State and Capabilities Information.

This step consists of online (preferably in real time) gathering of the information concerning the capabilities and channel state. This may include, for example, gathering parameters relevant for the following data/information:
a. Channel matrix/matrices
b. Noise intensity
c. List of available MIMO modes
d. Mobility estimation or an indication of mobility
   3. Retrieving Parameters from the Relevant Modes Database of Step 1

Equipped with the updated data/information parameters of step 2, the relevant modes database of step 1 is retrieved—for creating a concurrent list of only the relevant MIMO modes for the instantaneous channel and current system conditions.

### 4. Excluding Some MIMO Modes Off the List

Following is the exclusion of MIMO modes from the list of step 3, for which the available channel matrix is insufficient.

For instance, based on a single antenna transmission (even if received by multiple receive antennas), it is impossible to estimate the channel condition corresponding to schemes employing multiple transmit antennas, thus it is required to exclude such MIMO modes.

The modes left at the end of this step would be referred to as “currently relevant modes”.

### 5. Calculating PCINR

The post processing per tone physical CINR is calculated for each of the currently relevant MIMO modes. For instance in the case of MRC, the post processing per tone physical CINR is an estimate of:

$${PPCINR}_{MRC} = \frac{{\vert {h}_{i} \vert}^{2}}{{σ}^{2}}$$

where hᵢ is the channel to the i-th Rx antenna and σ is the noise intensity.

### 6. Invoking an ECINR Mechanism for Each of the Currently Relevant Modes

Invoking an ECINR mechanism, which may be available at the communication system, for each of the currently relevant modes with all possible Modulation Coding Schemes (MCS) and FEC sizes, such as according to the capabilities discussed hereinbefore.

For instance, in case the currently relevant modes are SM (Spatial Multiplexing) 2×2 and STC (Space Time coding) 2×2, and the available MCS are QPSK rate ½ and 16QAM rate ½, then the ECINR mechanism may be invoked for each of the following combinations of MIMO mode and MCS:

a. SM 2×2 QPSK ½
b. SM 2×2 16QAM ½
c. STC 2×2 QPSK ½
d. STC 2×2 16QAM ½

For each of the combinations above, the ECINR mechanism is invoked with the per-tone physical CINR (PCINR).

The ECINR mechanism is used in order to provide an estimate of the bit error rate (BER) or packet error rate (PER) for each of the combinations.

Thus, for all of the remaining combinations, the currently relevant modes and the available MCS possibilities, ECINR estimation is calculated. The ECINR values are a function of CINR values, which are measured and can be provided from the digital communication system, either directly, since they would probably be collected, such as the case in OFDMA systems, or they may be collected and/or derived by measurements and/or calculations, as known in the art for gathering CINR or equivalent information.

### 7. Choosing the Optimal MIMO Mode and MCS Combination.

Choosing the optimal MIMO mode and MCS combination based on the results of step 6 would allow providing a parameters' combination with highest throughput, subject to the QoS requirements and based on the ECINR mechanism output.

End of steps 1-7

A key issue of the method described hereinbefore is ECINR computation. Various schemes for ECINR calculation were developed in the last decade: exponential effective SINR mapping (EESM) method, mutual information effective CINR method (MIESM), mutual information effective CINR mapping (MIESM) (see e.g. [7], [6] and references therein. Recently the generalized EESM (GEESM) technique was introduced at [5]. GEESM was shown to provide an accurate ECINR estimator for any QoS requirements set.

Any one or more of the method's steps in FIG. 1 may be done at one or more base stations (BS) and/or one or more mobile stations (MS) and/or at any other software/hardware unit or layer of the communication network. In addition, some of the data/information parameters may be partially available in only one location, such as at a BS, thus it may be possible to collect and gather all the data/information parameters to one location, such as by using the communication network itself for that purpose.

The method can be repeated 7, such as once at fixed time intervals, or each time an OFDMA's frame is received. A digital communication system may provide new information relevant to step 2 and then it may be possible to repeat the method as well.

The method is not directly repeated, when there is no need to provide a new optimal mode or the MCS parameters of step 7, or as long as there is no new data to be gathered.

In addition, the operation 10 is not repeated, and step 11 is defined as “yes” if there is a need to perform step 1 again—to construct a new offline database, such as if there is a major change in the communication system PHY, or if there is a need to perform a new different session, such as with a different MS subscriber.

When there is no need to perform the method, the method ends 12. As long as there is a need to perform the method, it can be repeated when required, by the repeat operation 10, or by using another database 11, which may be equivalent to restarting the method.

**End of method**

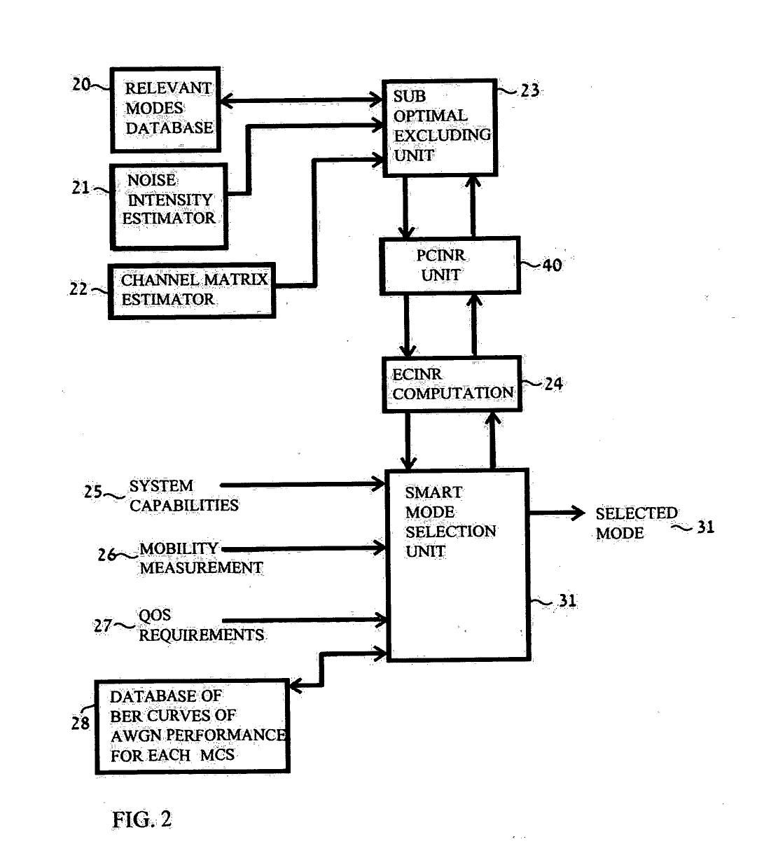

FIG. 2 details a hardware mechanism capable of selecting the optimal MIMO mode and MCS combination. For example, the selected method may be provided as a digital output 31 of a hardware unit. In addition, this mechanism can be implemented within one or more software, hardware and/or PHY layers of a communication system. Thus the mechanism's units need not be physically present.

A smart mode selection unit 30 provides selected mode information 31, based on commands and data provided directly 25, 26 and 27; and also from the mechanism's subunit 24 and a database 28.

The directly provided data may include system capabilities 25 such as known physical limitations, Mobility measurement 26 such as Doppler parameters, delays and QoS requirements 27 such as the allowed error probability and acceptable performance.

This data can be provided by software or from external sources as well, such as from other layers, other components of the communication network, MS etc.

In addition any one or more of these parameters may be already known and thus kept in memory.

The database 28, may keep in digital form the calculated known values of BER or PER curves of AWGN performance for each MCS.

For each MCS, a graph of the BER or PER vs. SNR can be kept.

Since the ECINR data is indicative of equivalent AWGN system, the resulting BER or PER can be estimated by the Smart unit 30.

Thus, the Smart unit 30 can receive data, such as by QoS requirements 27, of allowed BER or PER, and can estimate which MCS can be used, by checking the relevant database's BER or PER curves 28.

It may be possible to design such a database 28 in advance, such as by providing lab simulation results of known channels.

Thus, it may be easier to emulate and adjust the system to real conditions using this database.

The database may be kept as part of a communication's system memory. It may also be adjusted and updated by the smart mode selection unit 30.

ECINR computation unit 24 calculates the estimated ECINR based on data provided. This can be done in a similar manner to that described in the method of FIG. 1, with regards to ECINR calculation.

Relevant modes are retrieved from database 20 and provided to the ECINR unit 24.

The relevant modes database 20 may hold a list of transmission-reception (TR) methods relevant for each of the possible MIMO configurations, and mobility characterization.

The database 20 may be loaded, such as from a memory or from a wired or wireless network. Since the type of communication about to be made is known, it is possible to construct a database only with the relevant modes, which can be used in that session.

Noise intensity estimator unit and Channel matrix estimator 21 and 22 respectively, may provide PHY measurements and/or calculated results, this may be required for computing or providing CINR data of each subcarrier, for example.

A sub optimal excluding unit 23, may use information provided, such as:
Channel matrix/matrices, from unit 22
Noise intensity, from noise intensity estimator 21
List of available MIMO modes, from database 20
Mobility estimation or indication of mobility, such as from the mobility measurement 26

Unit 23 may use the information provided for creating a concurrent list of only the relevant MIMO modes for the instantaneous channel and current system conditions.

Unit 23 will preferably exclude MIMO modes, for which the available channel matrix is insufficient. For instance, based on a single antenna transmission (even if received by multiple receive antennas), it is impossible to predict the channel condition corresponding to schemes employing multiple transmit antennas, thus it may be required to exclude such MIMO modes. The modes left will be referred as “currently relevant modes”, and will be provided to PCINR unit 40, which would calculate the PCINR for each of the currently relevant modes and provide the PCINR values to the ECINR unit 24.

The ECINR computation unit 24 may communicate such as through the PCINR unit 40 with the sub optimal unit 23 and the smart unit 30, for providing concurrent ECINR estimations based on real time channel and noise measurements.

For instance, in case the currently relevant modes are SM 2×2 and STC 2×2, and the available MCS are QPSK rate ½ and 16QAM rate ½, then the ECINR unit 24 may be invoked for each of the following combinations of MIMO mode and MCS:
e. SM 2×2 QPSK ½
f. SM 2×2 16QAM ½
g. STC 2×2 QPSK ½
h. STC 2×2 16QAM ½

For each of the combinations above, the ECINR unit 24 is invoked with the per-tone physical CINR (PCINR) such as from unit 40. The ECINR unit 24 is used in order to provide an estimate of the BER or PER for each of the combinations.

Thus, for all of the remaining combinations the currently relevant modes and available MCS possibilities, an ECINR estimation is calculated. The ECINR values are a function of CINR values, which are measured and can be provided from the digital communication system, either directly, since they would probably be collected, such as the case in OFDMA systems, or they may be collected and/or derived by measurements and/or calculations, as known in the art for gathering CINR or equivalent information.

The smart mode selection unit 30 will provide the optimal. MIMO mode and MCS combination decision, such as through a digital data bus 31, or it may be provided within the communication's system memory. Preferably, this information will be directed to set the PHY mode of operation.

It will be recognized that the foregoing is but one example of a device and method within the scope of the present invention, and that various modifications will occur to those skilled in the art upon reading the disclosure set forth hereinbefore, together with the related drawings.

1. A Method for selecting an optimal ECINR mode in a digital communication system, comprising the steps:
A. Constructing an offline database referred to as: “relevant modes database”, which is comprised of a list of transmission-reception (TR) methods relevant for each of possible MIMO configurations, and mobility characterization;
B. Gathering online channel state and capabilities information;
C. Retrieving parameters from the relevant modes database of step A, based on the updated data/information of step B for creating a concurrent list;
D. Excluding some MIMO modes off the list, for which the available channel matrix is insufficient, the modes left at the end of this step are referred to as “currently relevant modes”;
E. Calculating post processing per tone physical CINR (PCINR) for each of the currently relevant modes found in step D;
F. Calculating ECINR for each of the currently relevant modes using the PCINR;
G. Choosing the optimal MIMO mode and MCS combination, which is the parameters' combination with highest throughput, which provide the best ECINR under QoS requirements.

2. The Method for selecting an optimal ECINR mode according to claim 1, wherein the digital communication system is an OFDMA system.
